(19) United States
(12) Patent Application Publication
(10) Pub. No.: US 2017/0082575 A1
(43) Pub. Date: Mar. 23, 2017

(54) DETERMINATION METHOD AND ELECTROCHEMICAL DEVICE FOR ELECTROCHEMICAL TEST STRIP

(71) Applicant: DELBio, INC., TAOYUAN CITY (TW)

(72) Inventors: TSUNG-HSUAN TSAI, TAOYUAN CITY (TW); CHIH-CHENG YANG, TAOYUAN CITY (TW)

(21) Appl. No.: 15/008,113

(22) Filed: Jan. 27, 2016

(30) Foreign Application Priority Data
Sep. 23, 2015 (TW) 104131375

(51) Int. Cl. G01N 27/416

(52) U.S. Cl. CPC G01N 27/4163

(57) ABSTRACT

An method for determining sample volume sufficiency of an electrochemical test strip having a reaction portion and two electrodes, wherein parts of the two electrodes are respectively disposed on the reaction portion, includes: placing a sample on the reaction portion; applying a first voltage to the sample for a first time period to drive a first current between two electrodes; applying a second voltage to the sample for a second time period to drive a second current between the two electrodes; calculating an absolute value of the ratio of a value of the first current to a value of the second current as a sample volume index; and comparing the sample volume index with a predetermined index range to determine if a volume of the sample is insufficient to measure accurately at least one characteristic of the sample.

### CROSS REFERENCE TO RELATED APPLICATIONS

This Non-provisional application claims priority under 35 U.S.C. §119(a) on Patent Application No(s). 104131375 filed in Taiwan, Republic of China on Sep. 23, 2015, the entire contents of which are hereby incorporated by reference.

### BACKGROUND OF THE INVENTION

Field of Invention

The invention relates to a method and device for determining sample volume sufficiency of a test strip and, in particular, to a method and device for determining sample volume sufficiency of an electrochemical test strip.

Related Art

Electrochemical analysis method is commonly used in the substance determination or concentration determination. It develops into a test-and-know sensor due to its rapid and convenient determination, and it is commonly a testing strip. The electrochemical analysis method can be applied to many fields, such as environment, agriculture, medicine or biochemistry. In environmental determination, the electrochemical analysis method can be used for detecting heavy metal contaminants such as mercury (Hg), lead (Pb) and cadmium (Cd), and it is a heavy metal determination method with high sensitivity and requiring low concentration. In agriculture, the electrochemical analysis method has developed into a simple and inexpensive sensor with which farmers can sample soil and water in fields for monitoring the heavy metal contents in the cultivated soil and the irrigation water anytime and anywhere. Moreover, it may be used for detecting antibiotic or pesticide residues in food, fruits or vegetables. In medicine, the electrochemical analysis method succeeds in applying to the test strip as the domestic blood-glucose meter.

The test strip described in the disclosure is designed with the principle of electrochemical detection technology, and it is called an electrochemical test strip. In general, the test strip has two electrodes and a space for accommodating a sample (reaction portion) so the sample and the reagent on the electrode surface (or the reagent partially contacting the electrodes) can generate corresponding electrochemical reaction, and thus a current value depending on the concentration of the sample can be detected. In other words, the concentration of the sample can be deduced from the current value. The sample changes with the application field of the testing strip. For example, the sample may be soil or water from the environment, an ingredient, a fruit, a vegetable, or a blood sample for blood glucose detection.

However, the conventional electrochemical testing strip does not have high threshold for the trigger current value generated by the electrochemical reaction, so the sensing procedure easily starts soon after the switch is turned on but an determination for the abnormal condition may not be effectively executed before the sensing procedure (unless the test strip is fully damaged or seriously defective). Therefore, the user may obtain sensing data generated by the abnormal electrochemical test strip. Further, when the user operates the measurement device having an electrochemical test strip, the sample may not fully cover two electrodes (reaction portion) while injected into the electrochemical test strip due to unfamiliar operation or other factors, for example a thick sample. Therefore, the detected value may have a deviation. A conventional method for determining sample volume sufficiency determines whether the sample exists between two electrodes. If not, a closed circuit cannot form for conduction. However, this method cannot find out the distribution of the sample on the electrodes (reaction portion) so the abnormal condition of the sample injection cannot be effectively detected and causes a mistake result which results in a misjudgment by a user. Especially, when the test strip is applied to the medicine field, for example a blood glucose test strip, the abnormal reading result may be dangerous to the user's health and safety.

Currently, the ex-factory electrochemical test strip lacks a mechanism or a design for effectively detecting abnormal conditions, such as a design for detecting resistance of the circuit of the test strip or detecting the enzyme content of the reagent. Therefore, not only the value is unable to be shown completely, but the user is not aware of the abnormal condition of the test strip and continues using the abnormal test strip.

### SUMMARY OF THE INVENTION

An aspect of the disclosure is to provide a method and device for determining the sample volume sufficiency of an electrochemical test strip while using the electrochemical test strip to avoid a misjudgment by a user.

A method for determining sample volume sufficiency of an electrochemical test strip having a reaction portion and two electrodes, wherein parts of the two electrodes are respectively disposed on the reaction portion, includes the steps of: placing a sample on the reaction portion of the electrochemical test strip; applying a first voltage to the sample for a first time period to drive a first current between the two electrodes; applying a second voltage to the sample for a second time period to drive a second current between the two electrodes; calculating an absolute value of the ratio of a value of the first current to a value of the second current as a sample volume index; and comparing the sample volume index with a predetermined index range to determine if a volume of the sample is insufficient to measure accurately at least one characteristic of the sample; wherein the first voltage and the second voltage have opposite directions.

In one embodiment, the volume of the sample is determined to be insufficient as the value of the sample volume index is out of the predetermined index range, and the volume of the sample is determined to be sufficient as the value of the sample volume index is within the predetermined index range.

In one embodiment, the method further includes the steps of: sending a normality message as the value of the sample volume index is within the predetermined index range; and sending an error signal as the value of the sample volume index is out of the predetermined index range.

In one embodiment, a positive correlation exists between the predetermined index range and the ratio of a first area to a second area, and a negative correlation exists between the predetermined index range and the ratio of the square root of the first time period to the square root of the second time period, wherein the first area indicates the area of the part of one electrode, and the second area indicates the area of the part of the other electrode.

In one embodiment, the predetermined index range is calculated based on the following equation:

$$\frac{\frac{A 1}{\sqrt{t 1}}}{\frac{A 2}{\sqrt{t 2}}} \times \frac{1}{( 1 + C \% )} ∼ \frac{\frac{A 1}{\sqrt{t 1}}}{\frac{A 2}{\sqrt{t 2}}} \times ( 1 + C \% )$$

wherein a first area A1 indicates the area of the part of one electrode, a second area A2 indicates the area of the part of the other electrode, t1 indicates the first time period, t2 indicates the second time period, and C indicates a tolerance ratio of the electrochemical test strip.

In one embodiment, the first time period and the second time period are between 0.5 seconds and 5 seconds.

In one embodiment, the predetermined index range is between 1.02 and 2.2.

In one embodiment, an absolute value of the first voltage is equal to that of the second voltage and between 0.1 volt and 1 volt.

In one embodiment, the method further includes the step of interrupting power for a third time period after the step of placing the sample on the reaction portion of the electrochemical test strip.

In one embodiment, the first time period is equal to the second time period.

In one embodiment, the first time period is not equal to the second time period.

An electrochemical device for determining sample volume sufficiency of an electrochemical test strip having a reaction portion and two electrodes, wherein parts of the two electrodes are respectively disposed on the reaction portion, includes a strip accommodating region, a power supply unit, a current sensing unit, and a processing unit. The strip accommodating region is used for accommodating the electrochemical test strip. The power supply unit applies a first voltage to a sample for a first time period to drive a first current between the two electrodes, and applies a second voltage to the sample for a second time period to drive a second current between the two electrodes. The current sensing unit is used for obtaining a value of the first current and a value of the second current. The processing unit is used for calculating an absolute value of the ratio of the value of the first current to the value of the second current as a sample volume index, and for comparing the sample volume index with a predetermined index range to determine if a volume of the sample is insufficient to measure accurately at least one characteristic of the sample. The first voltage and the second voltage have opposite directions.

In one embodiment, the volume of the sample is determined to be insufficient as the value of the sample volume index is out of the predetermined index range, and the volume of the sample is determined to be sufficient as the value of the sample volume index is within the predetermined index range.

In one embodiment, the processing unit sends a normality message as the value of the sample volume index is within the predetermined index range, and sends an error signal as the value of the sample volume index is out of the predetermined index range.

In one embodiment, a positive correlation exists between the predetermined index range and the ratio of a first area to a second area, and a negative correlation exists between the predetermined index range and the ratio of the square root of the first time period to the square root of the second time period, wherein the first area indicates the area of the part of one electrode, and the second area indicates the area of the part of the other electrode.

In one embodiment, the predetermined index range is calculated based on the following equation:

$$\frac{\frac{A 1}{\sqrt{t 1}}}{\frac{A 2}{\sqrt{t 2}}} \times \frac{1}{( 1 + C \% )} ∼ \frac{\frac{A 1}{\sqrt{t 1}}}{\frac{A 2}{\sqrt{t 2}}} \times ( 1 + C \% )$$

wherein a first area A1 indicates the area of the part of one electrode, a second area A2 indicates the area of the part of the other electrode, t1 indicates the first time period, t2 indicates the second time period, and C indicates a tolerance ratio of the electrochemical test strip.

In one embodiment, the first time period and the second time period are between 0.5 seconds and 5 seconds.

In one embodiment, the predetermined index range is between 1.02 and 2.2.

In one embodiment, an absolute value of the first voltage is equal to that of the second voltage and between 0.1 volt and 1 volt.

In one embodiment, before the power supply unit applies the first voltage, power is interrupted for a third time period.

In one embodiment, the first time period is equal to the second time period.

In one embodiment, the first time period is not equal to the second time period.

As mentioned above, the method and device for determining sample volume sufficiency of an electrochemical test strip use the sample to generate currents having opposite directions by the electrochemical reaction. Namely currents are driven from the second electrode to the first electrode and from the first electrode to the second electrode. As a result, the first current value and the second current value are obtained. The absolute value of the ratio of the first current value to the second current value is regarded as the sample volume index, and then the value of the sample volume index is compared with the predetermined index range. The sample volume sufficiency is determined by comparing the value of the sample volume index with the predetermined index range to avoid a misjudgment by a user. The determination method of the disclosure does not need to actually calculate the areas covered by the sample on the first electrode and the second electrode, but defines the sample volume index and the predetermined index range instead. It can omit complex steps of calculating the areas covered by the sample on the first electrode and second electrode, and as accurate as possible determine whether the sample volume is sufficient or not.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of the steps of the method for determining the sample volume sufficiency of an electrochemical test strip according to an embodiment;

FIG. 2 is an exploded view of the electrochemical test strip according to an embodiment;

FIG. 3 is a schematic block diagram of the electrochemical device applied to the determination method shown in FIG. 1;

FIG. 4 is a schematic diagram showing sample volume sufficiency of the electrochemical test strip in FIG. 3;

FIG. 5 is a schematic diagram showing the currents driven by taking the second electrode as the working electrode and then taking the first electrode as the working electrode;

FIGS. 6A and 6B are schematic diagrams showing the results of sample volume index obtained by placing different samples on the electrochemical test strips;

FIG. 7 is a schematic diagram showing the insufficient sample filling conditions of the electrochemical test strip according to an embodiment; and

FIGS. 8A to 8C are schematic diagrams showing the results of deviation value obtained by placing samples with different volumes on the electrochemical test strips and comparing the results with those of standards.

### DETAILED DESCRIPTION OF THE INVENTION

The embodiments of the invention will be apparent from the following detailed description, which proceeds with reference to the accompanying drawings, wherein the same references relate to the same elements.

In this embodiment, the electrochemical testing strip employs the electrochemical determination technology, and directly called the “testing strip” hereinafter for convenient illustration. Furthermore, the testing strip of this embodiment can be applied to many fields, such as environment determination, food determination, or medical blood-glucose detection, which are not limited thereto. For the convenient understanding, the following embodiments take the electrochemical testing strip applied to the blood-glucose detection as examples for the illustration.

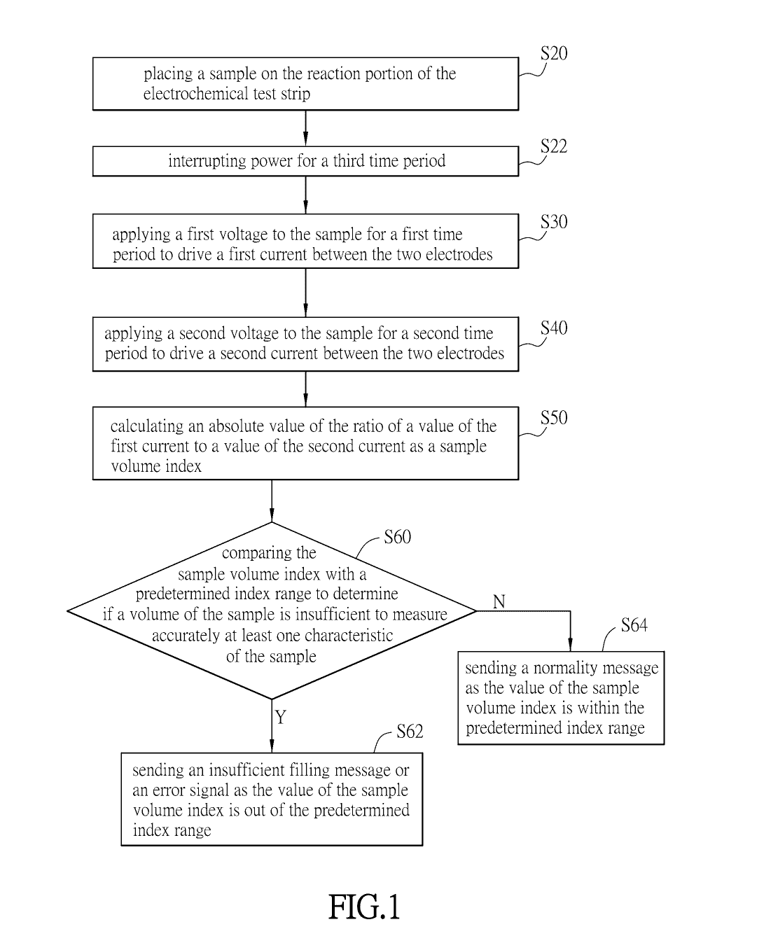

FIG. 1 is a flow chart of the steps of the method for determining the sample volume sufficiency of an electrochemical test strip according to an embodiment. Referring to FIG. 1, the above mentioned method is abbreviated to the determination method in the embodiment for convenient illustration. The determination method includes the following steps of: placing a sample on the reaction portion of the electrochemical test strip (step S20); applying a first voltage to the sample for a first time period to drive a first current between the two electrodes (step S30); applying a second voltage to the sample for a second time period to drive a second current between the two electrodes (step S40); calculating an absolute value of the ratio of a value of the first current to a value of the second current as a sample volume index (step S50); comparing the sample volume index with a predetermined index range to determine if a volume of the sample is insufficient to measure accurately at least one characteristic of the sample (step S60); sending an insufficient filling message or an error signal as the value of the sample volume index is out of the predetermined index range (step S62); and sending a normality message as the value of the sample volume index is within the predetermined index range (step S64). The first time period and the second time period may be uninterrupted.

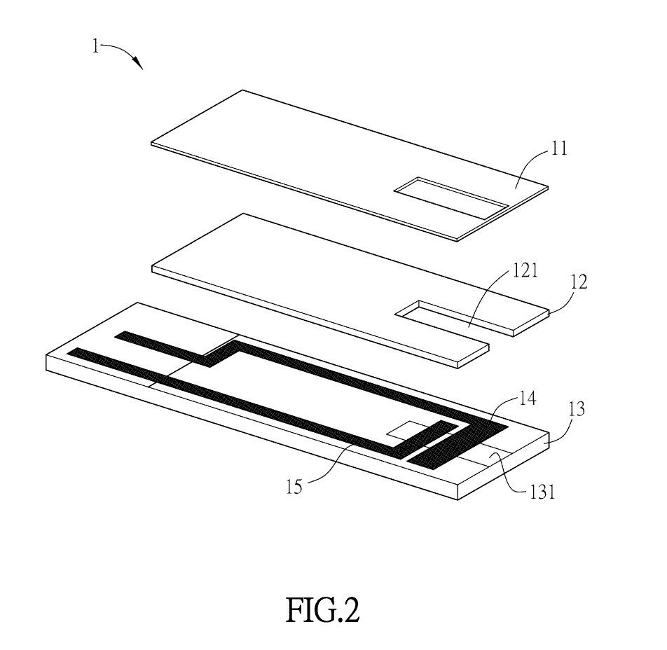

First, provide an electrochemical test strip 1. FIG. 2 is an exploded view of the electrochemical test strip according to an embodiment. Referring to FIG. 2, the electrochemical test strip 1 of the embodiment may include an upper cover layer 11, an interlayer 12, a substrate layer 13, a first electrode 14, and a second electrode 15. The substrate layer 13 is an electrical insulation substrate. The material of the substrate layer 13 may be polyvinyl chloride, polystyrene, polyester, polycarbonate, polyether, polyethylene, polypropylene, polyethylene terephthalate, silicon dioxide, or aluminium oxide, but it is not limited thereto. In the embodiment, the materials of the first electrode 14 and the second electrode 15 may be carbon, metal, alloy, or other electrically conductive materials, and the electrodes have designate patterns printed by the screen printing method. Moreover, relative positions, shapes and sizes of the first electrode 14 and the second electrode 15 are not limited. One end of the substrate layer 13 has a reaction portion 131, and a part of the first electrode 14 and a part of the second electrode 15 are disposed on or cover the reaction portion 131. The reaction portion 131 of the embodiment contains a chemical reagent which at least has an electron transfer substance and may have other substances: an enzyme that reacts with the sensing object, a macromolecule, a stabilizer or the like.

In detail, the interlayer 12 is disposed on the substrate layer 13 and has an injection portion 121 (an opening) corresponding to the reaction portion 131. Thus, a space for accommodating the sample may be defined by combining the interlayer 12 with the substrate layer 13 if the interlayer 12 is thick enough. Therefore, in the step S20, the user can place or inject the sample through the injection portion 121 of the interlayer 12. In the following embodiments, the sample is liquid whole blood for example. After entering the injection portion 121 of the interlayer 12, the blood (the sample) may cover the parts of the first electrode 14 and the second electrode 15 on the reaction portion 131. When the first electrode 14 and the second electrode 15 contact the sample, the subsequent electrochemical reaction occurs. The determination method of the embodiment can determine the distribution of the sample on the first electrode 14 and the second electrode 15, namely the sample volume sufficiency.

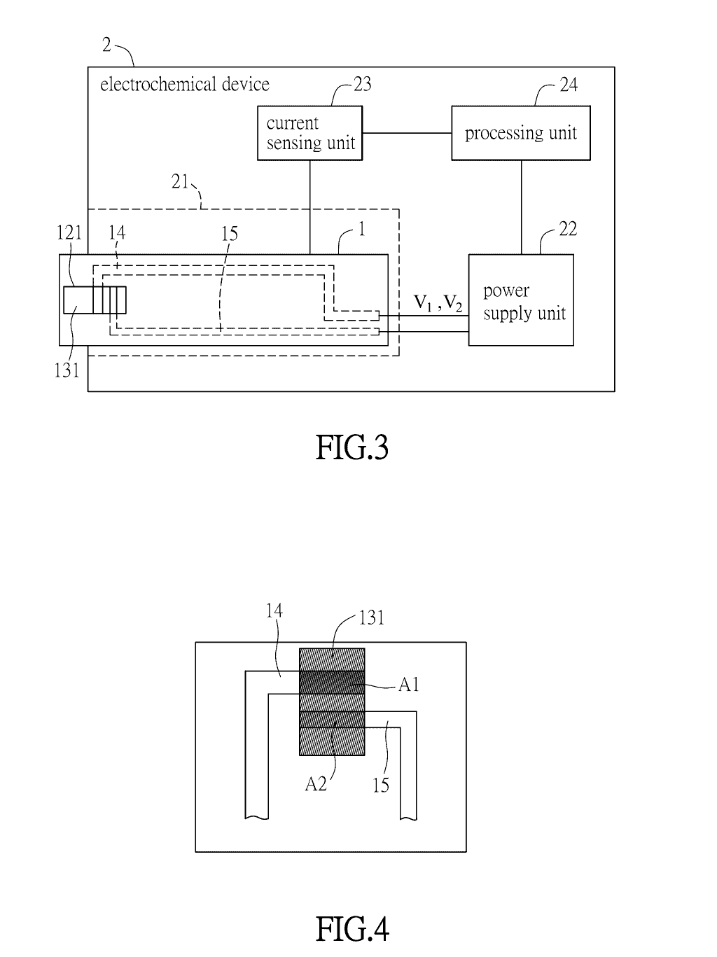

Moreover, the details of each step in the embodiment will be more apparent from the following illustration with an electrochemical device 2. That is to say, the electrochemical device 2 may be used to execute the determination method of the embodiment for determining sample volume sufficiency of the electrochemical test strip 1. The electrochemical device 2 may be a detecting apparatus for the electrochemical test strip 1, for example a blood glucose meter. FIG. 3 is a schematic block diagram of the electrochemical device applied to the determination method shown in FIG. 1. Referring to FIGS. 1 to 3, the electrochemical device 2 of the embodiment includes a strip accommodating region 21, a power supply unit 22, a current sensing unit 23, and a processing unit 24. The strip accommodating region 21 is used for accommodating the disposable electrochemical test strip 1, and the electrochemical test strip 1 is used for receiving a sample.

Providing the electrochemical test strip 1 may indicate that the user put the disposable electrochemical test strip 1 into the strip accommodating region 21. Then, in the step S20, the sample is injected at the injection portion 121 of the electrochemical test strip 1 and the reaction portion 131 allows the injection of the sample. The reaction portion 131 of the electrochemical test strip 1 receives the sample.

Preferably, the determination method may further include the step S22 of interrupting power for a third time period after placing the sample and before the step S30 that the power supply unit 22 applies the first voltage V₁. That is to say, the power supply unit 22 does not operate and just waits for 0.1 seconds to 2 seconds (the third time period) so that there is enough time for the sample filling the reaction portion 131 and contacting the chemical reagent in the reaction portion 131. Typically, the sample is sufficient to cover the reaction portion 131 appropriately so as to measure accurately at least one characteristic of the sample by the electrochemical device 2. At this time, the sample appropriately or fully covers the parts of the first electrode 14 and the second electrode 15 in the reaction portion 131. After that, a voltage applied between the first electrode 14 and the second electrode 15 can cause the electrochemical reaction of the sample. FIG. 4 is a schematic diagram showing the sample volume sufficiency of the electrochemical test strip in FIG. 3. As shown in FIG. 4, it shows one of the normal filling conditions of the sample as the sample (indicated by oblique lines in FIG. 4) fully covers the reaction portion 131. Preferably, the third time period may be 0.5 seconds to 2 seconds that can be adjusted according to the sample property. For example, it takes more time for the reaction portion 131 to be filled with a thick sample, so the third time period may be 2 seconds at this case. However, the third time period may be 0.5 seconds if the sample has general concentration.

Then, proceed to the step S30 and the step S40. The step S30 is to apply a first voltage V₁ to the sample for a first time period t1 to drive a first current (positive charge), for example, from the second electrode 15 to the first electrode 14 and thereby to obtain a first current value. At this case, the second electrode 15 is as a working electrode. The step S40 is to apply a second voltage V₂ to the sample for a second time period t2 to drive a second current, for example, from the first electrode 14 to the second electrode 15 and thereby to obtain a second current value. In this case, the first electrode 14 is as a working electrode. Moreover, the first voltage V₁ and the second voltage V₂ have opposite directions. For example, in the embodiment, the first voltage V₁ is a positive voltage, and the second voltage V₂ is a negative voltage. In some embodiments, the directions of the first voltage V₁ and the second voltage V₂ can be converse.

Preferably, the absolute values of the first voltage V₁ and the second voltage V₂ are equal and between 0.1 volt and 1 volt. In the embodiment, the first voltage V₁ is 0.3V, and the second voltage V₂ is −0.3V. Generally, after the current sensing unit 23 obtains the first current value and the second current value, the areas covered by the sample on the second electrode 15 and the first electrode 14 can be respectively calculated with the Cottrell equation depending on the first current value and the second current value. The Cottrell equation is:

$$i = \frac{{nFAc}_{j}^{0} \sqrt{{D}_{j}}}{\sqrt{π} i} .$$

i indicates current value (amp), N indicates the number of electrons when a closed circuit forms, F indicates Faraday constant (96,485 C/mol), A indicates the area of the electrode (cm²), cⱼ⁰ indicates the initial concentration of the reducible species j (mol/cm³), Dⱼ indicates the diffusion coefficient for species j (cm²/s), and t indicates time (second).

However, the determination method of the disclosure does not need to actually calculate the areas covered by the sample on the first electrode 14 and the second electrode 15, but defines the sample volume index and the predetermined index range instead (the details are illustrated below). It can omit the complex steps of calculating the areas covered by the sample on the first electrode 14 and the second electrode 15 and may not limit that the working electrode is the first electrode 14 or the second electrode 15.

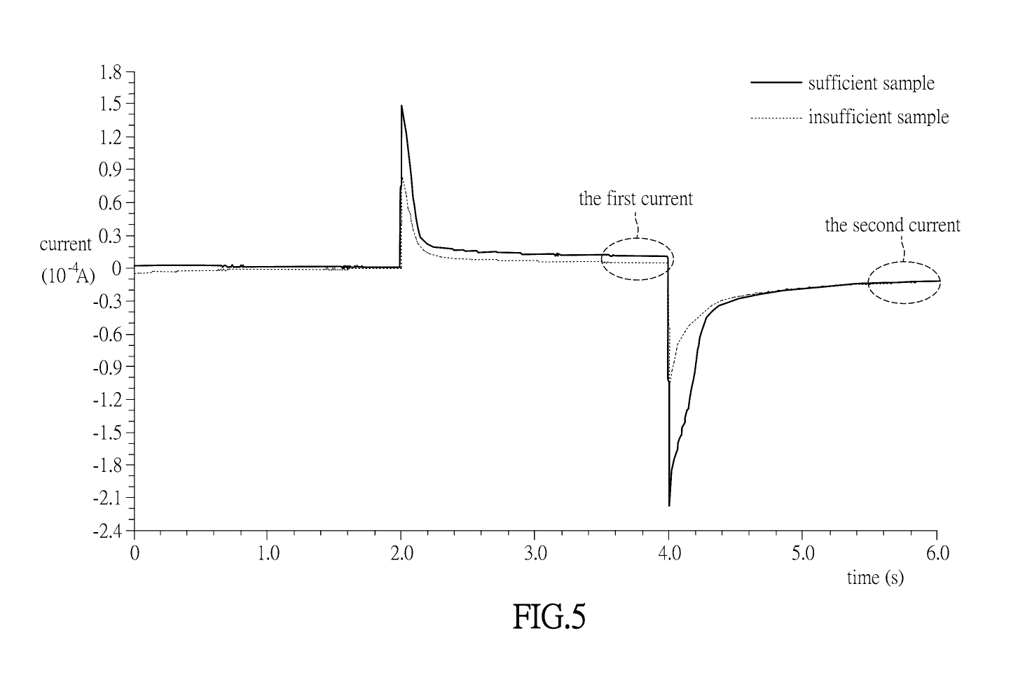

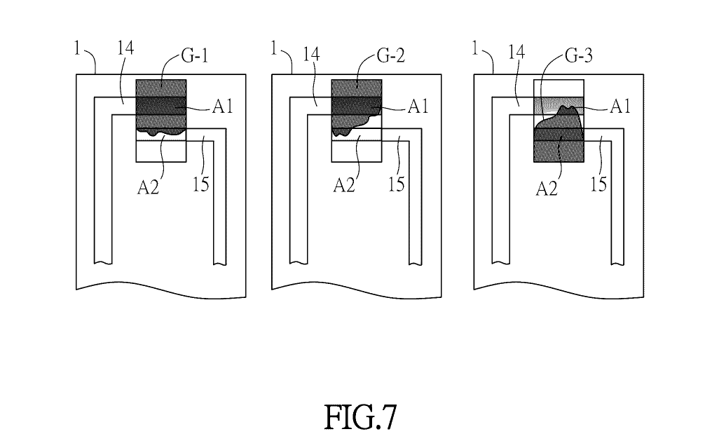

The detection of the first current and the second current may refer to FIG. 5. FIG. 5 is a schematic diagram showing the currents driven by taking the second electrode 15 as the working electrode and then taking the first electrode 14 as the working electrode. In detail, the power supply unit 22 may apply a positive voltage to the sample to make the voltage level of the first electrode 14 less than that of the second electrode 15. Thus, the first current is driven from the second electrode 15 to the first electrode 14. Then the power supply unit 22 may apply a negative voltage to the sample to make the voltage level of the second electrode 15 less than that of the first electrode 14. Thus, the second current is driven from the first electrode 14 to the second electrode 15. It can be seen from FIG. 5 that the stable value (dotted circle) of the first current detected from “the sufficient sample” greatly differs from that detected from “the insufficient sample”, and the stable values of the second currents detected from the sufficient sample and the insufficient sample are similar. It infers that the insufficient sample does not fully cover the second electrode 15 as the working electrode driving the first current, and the possible distribution may be like the sample G-1 in FIG. 7.

Then, in the step S50, a sample volume index is obtained by calculating the absolute value of the ratio of the first current value to the second current value.

$$sample volume index = \vert \frac{first current value}{second current value} \vert$$

The step S60 is to compare the sample volume index with the predetermined index range. The predetermined index range of the embodiment is obtained according to the Cottrell equation, more specifically, by calculating the areas of the first electrode 14 and the second electrode 15, the time periods of applying the first voltage V₁ and the second voltage V₂, and a tolerance ratio. For example, if the part of the first electrode 14 has a first area A1, the part of the second electrode 15 has a second area A2, the first voltage V₁ is applied for a first time period t1, the second voltage V₂ is applied for a second time period t2, and the electrochemical test strip 1 has a tolerance ratio C, the predetermined index range may be calculated based on the following equation:

$$\frac{\frac{A 1}{\sqrt{t 1}}}{\frac{A 2}{\sqrt{t 2}}} \times \frac{1}{( 1 + C \% )} ∼ \frac{\frac{A 1}{\sqrt{t 1}}}{\frac{A 2}{\sqrt{t 2}}} \times ( 1 + C \% ) .$$

As shown in FIG. 4, the first area A1 of the embodiment indicates the area of the first electrode 14 located in the reaction portion 131, and the second area A2 indicates the area of the second electrode 15 located in the reaction portion 131. Because the areas of the first electrode 14 and the second electrode 15 of the electrochemical test strips 1 with the same standard are constant, the ratio of the first area A1 to the second area A2 is also a constant value. Further, the time periods of applying the first voltage V₁ and the second voltage V₂ may be set equal, so the ratio of the square root of the first time period t1 to the second time period t2 is also a constant value. Preferably, the first time period t1 and the second time period t2 may be between 0.5 seconds and 5 seconds. Namely, in the step S30, the periods of applying the first voltage V₁ and the second voltage V₂ may be between 0.5 seconds and 5 seconds. In the embodiment, the first time period t1 and the second time period t2 are both 2 seconds for example. In the present disclosure, the first time period t1 may be equal or not equal to the second time period t2. The predetermined index range may be defined based on the above equation for further determination in the following step.

The tolerance ratio C of the electrochemical test strip 1 may vary with the sensitivity of the electrochemical test strip 1. For example, if the area covered by the sample of the first electrode 14 and the second electrode 15 is 60% and the accuracy of the electrochemical device 2 for detecting glucose concentration of the sample is still kept, the tolerance ratio C is 40. In the embodiment, the ratio of the first area A1 to the second area A2 is 1.5. If the absolute values of the first voltage V₁ and the second voltage V₂ are equal and the applying time periods are set equal, the predetermined index range as the following result can be obtained with the above equation:

$$1.5 \times \frac{1}{( 1 + 40 \% )} ∼ 1.5 \times ( 1 + 40 \% ) .$$

As a result, the predetermined index range of the embodiment is between 1.07 and 2.10. Moreover, the above mentioned equation for calculating the predetermined index range shows that a positive correlation exists between the predetermined index range and the ratio of the first area A1 to the second area A2, and a negative correlation exists between the predetermined index range and the ratio of the square root of the first time period t1 to the square root of the second time period t2. In some embodiments of the present invention, the predetermined index range is between 1.02 and 2.2 as the tolerance ratio C is 46.67.

After the above description defines the predetermined index range, the predetermined index range of the embodiment is between 1.02 and 2.2 for example. The predetermined index range may be stored in the processing unit 24 in advance, and the processing unit 24 executes the step S60 as shown in FIG. 1. The processing unit 24 compares the obtained sample volume index with the predetermined index range to determine if a volume of the sample is insufficient to measure accurately at least one characteristic of the sample, e.g. the concentration of glucose in the sample of whole blood. More specifically, the processing unit 24 determines whether the value of the sample volume index (i.e. the absolute value of the ratio of the first current value to the second current value) is within the predetermined index range. If the result is “no”, namely the value of the sample volume index is out of the predetermined index range, the step S62 is executed and the processing unit 24 determines that the volume of the sample is insufficient. In other words, the amount of the sample introduced into the reaction portion of the test strip is inadequate for accurate measurement. In the step S62 in this embodiment, the processing unit 24 may send an insufficient filling message or an error signal optionally to notify the user that a new electrochemical test strip should be provided and the processes of the determination method should be restarted. If the result is “yes”, namely the value of the sample volume index is within the predetermined index range, the step S64 is executed and the processing unit 24 determines that the volume of the sample is sufficient. In other words, the amount of the sample introduced into the reaction portion of the test strip is adequate for accurate measurement. In the step S64 in this embodiment, the processing unit 24 may send a normality message optionally and then proceed to the following measurement for some biological characteristics of the sample.

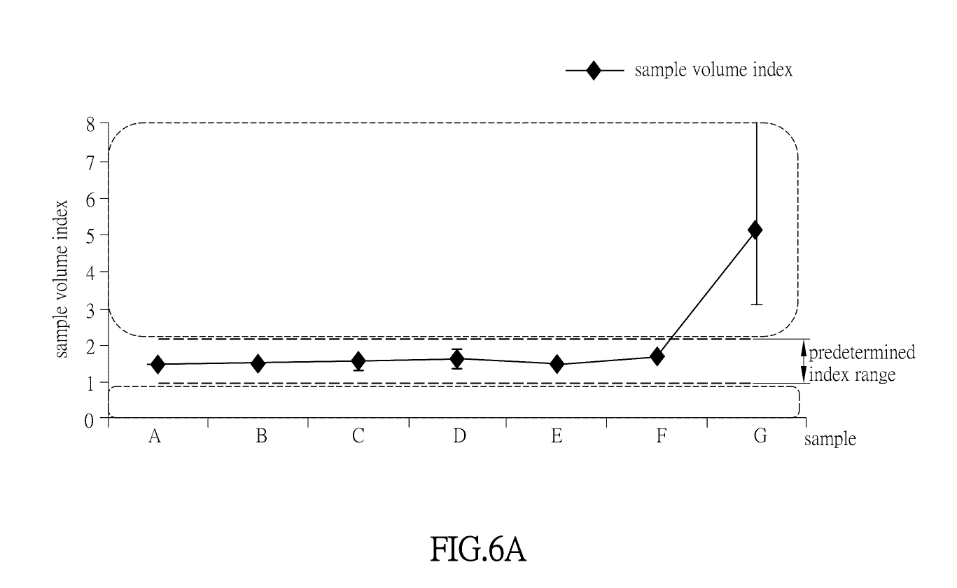

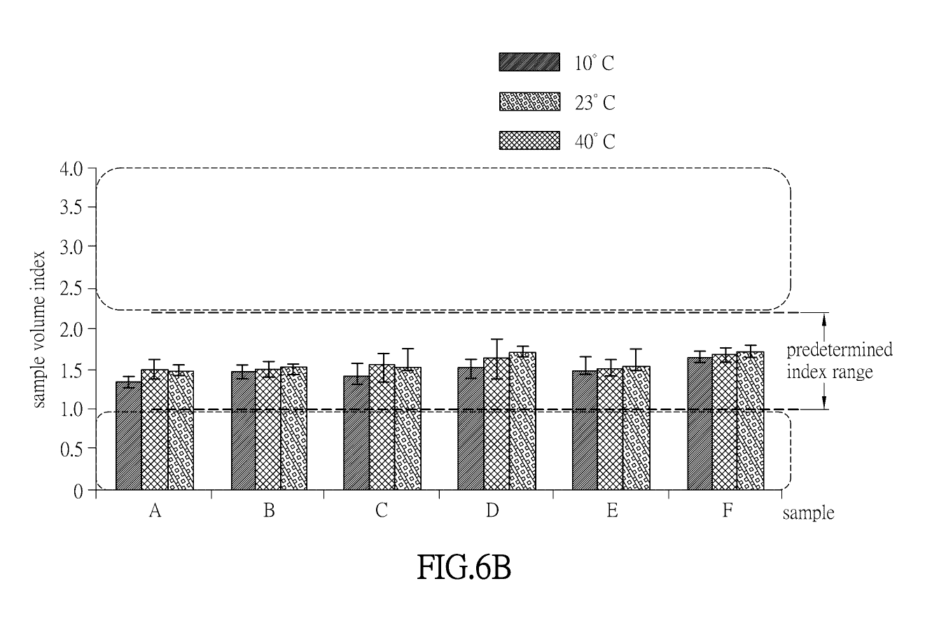

The step S60 to the step S64 are illustrated below with the experimental results shown in FIG. 6A. FIGS. 6A and 6B are schematic diagrams showing the results of sample volume index obtained by placing different samples on the electrochemical test strips. Table 1 shows the details of samples A to G shown in FIGS. 6A and 6B.

TABLE 1
Details of samples A to G shown in FIGS. 6A and 6B

| Sample | Details |
|---|---|
| A | sufficient volume, hematocrit (HCT): 10, |
| | concentration: 0-10 mg/dL |
| B | sufficient volume, hematocrit (HCT): 10, |
| | concentration: 550-600 mg/dL |
| C | sufficient volume, hematocrit (HCT): 70, |
| | concentration: 0-10 mg/dL |
| D | sufficient volume, hematocrit (HCT): 70, |
| | concentration: 550-600 mg/dL |
| E | sufficient volume, low GCS |
| F | sufficient volume, high GCS |
| G | insufficient volume |

As to sample E and sample F shown in Table 1, GCS (Glucose Control Solution) indicates a control solution used for examining blood glucose meter. Low GCS indicates a low concentration of glucose in the control solution, and this experimental example uses a control solution having a glucose concentration of 30-50 mg/dL. High GCS indicates a high concentration of glucose in the control solution, and this experimental example uses a control solution having a glucose concentration of 280-420 mg/dL. Referring to FIG. 6A and Table 1, it can be seen from FIG. 6A that the values of the sample volume index (i.e. the absolute values of the ratios of the first current value to the second current value) obtained from samples A-F are all within the predetermined index range, so the processing unit 24 determines the samples A-F with sufficient quantity and sends a normality massage at this time. However, the value of the sample volume index obtained from sample G is out of the predetermined index range, so the processing unit 24 determines the sample G has inadequate volume and sends an insufficient filling message or an error signal. The above description shows that the determination method is not affected by different glucose concentration or HCT percentage in the sample and may accurately determine whether the volume of the sample introduced into the reaction portion of the electrochemical test strip 1 is insufficient. Referring to FIG. 7, it is a schematic diagram showing the insufficient sample filling conditions of the electrochemical test strip according to an embodiment. After sample G with insufficient volume shown in Table 1 flows into the reaction portion of the electrochemical test strip 1, its distribution may be like the distribution (i.e. shaded region in the drawing) of sample G-1, sample G-2 or sample G-3 as shown in FIG. 7. In some embodiments, assuming that the tolerance ratio is 40%, the obtained value of the sample volume index (i.e. the absolute value of the ratio of the first current value to the second current value) will be out of the predetermined index range as shown in FIG. 6A if the area covered by the sample of the first area A1 and the second area A2 is less than 60%.

Moreover, samples with different temperatures also do not influence the accuracy of the determination method. Referring to FIG. 6B, it shows the sample volume indexes of samples A to F (the details refer to Table 1) at 10° C., 23° C., and 40° C. which are injected into the electrochemical test strip 1. These sample volume indexes are obtained by executing the step S30 and the step S40, and they are all within the predetermined index range. Therefore, the temperature of the sample does not affect the determination results of sample volume sufficiency as shown in FIG. 6B.

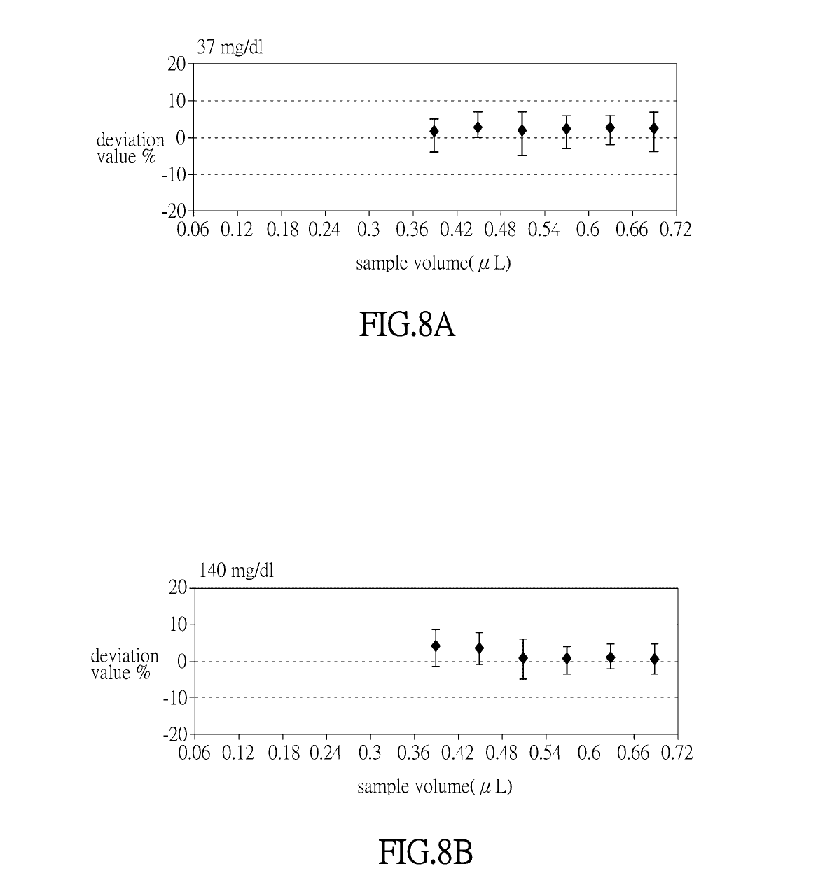

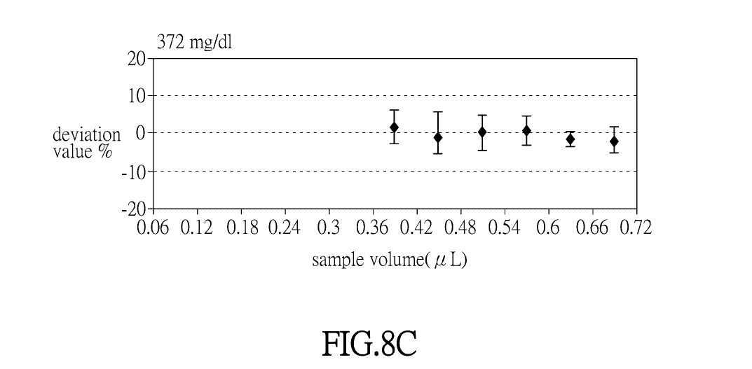

The tolerance ratio may be obtained by experiment. Referring to FIGS. 8A to 8C, they are schematic diagrams showing the results of deviation value obtained by placing the same sample with different volumes respectively on the electrochemical test strips for detecting blood glucose concentration, and comparing the results with the blood glucose concentration of the sample detected by the standard equipment (YSI). FIGS. 8A to 8C only shows the experimental results with deviation values within 10% in comparison with the result obtained by the standard equipment (YSI). As shown in FIGS. 8A to 8C, when the sample volume is less than 0.36 μL, the deviation value from the standard equipment (YSI) is greater than 10%. It infers that the accuracy of detecting blood glucose concentration reduces if the sample volume is less than 0.36 μL, which should be excluded from the normal reading range. In other words, the reaction portion 131 of the electrochemical test strip needs the sample of about 0.6 μL to be fully filled, and the detection fails if the sample volume is less than 0.36 μL. Accordingly, the determination tolerance ratio of the embodiment may be determined as 40%.

In another embodiment, the directions of first voltage and the second voltage can be converse. For example, the negative voltage may be applied to the sample first to drive a first current from the first electrode 14 to the second electrode 15, and then the positive voltage is applied to the sample to drive a second current from the second electrode 15 to the first electrode 14. The first and second currents of this embodiment and those of the above mentioned embodiment have opposite directions. However, it does not affect the absolute value of the ratio of the first current value to the second current value.

Moreover, another electrochemical device for the electrochemical test strip is provided. The electrochemical device includes a strip accommodating region, a power supply unit, a current sensing unit, and a processing unit. The strip accommodating region is used for accommodating an electrochemical test strip having a first electrode and a second electrode, and a part of the first electrode and a part of the second electrode are disposed at a reaction portion. The power supply unit applies a first voltage to the sample for a first time period to drive a first current from the second electrode to the first electrode, and applies a second voltage to the sample for a second time period to drive a second current from the first electrode to the second electrode. The current sensing unit is used for obtaining a first current value and a second current value. The processing unit is used for calculating an absolute value of the ratio of the first current value to the second current value as a sample volume index, and for comparing the sample volume index with a predetermined index range and then determining if the sample volume is insufficient to measure accurately at least one characteristic of the sample. Because the detailed elements of this electrochemical device and its executing actuation may refer to the electrochemical device 2 in the first embodiment, the related description is omitted here.

Similarly, the terms first and second in the disclosure are named for clear illustration but not for limitation.

In summary, the method and device for determining sample volume sufficiency of an electrochemical test strip use the sample to generate currents having opposite directions by the electrochemical reaction. Namely currents are driven from the second electrode to the first electrode and from the first electrode to the second electrode. As a result, the first current value and the second current value are obtained. The absolute value of the ratio of the first current value to the second current value is regarded as the sample volume index, and then the value of the sample volume index is compared with the predetermined index range. The sample volume sufficiency is determined by comparing the value of the sample volume index with the predetermined index range to avoid a misjudgment by a user. The determination method of the disclosure does not need to actually calculate the areas covered by the sample on the first electrode and the second electrode, but defines the sample volume index and the predetermined index range instead. It can omit complex steps of calculating the areas covered by the sample on the first electrode and second electrode, and as accurate as possible determine whether the sample volume is sufficient or not.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A method for determining sample volume sufficiency of an electrochemical test strip having a reaction portion and two electrodes, wherein parts of the two electrodes are respectively disposed on the reaction portion, the method comprising:
placing a sample on the reaction portion of the electrochemical test strip;
applying a first voltage to the sample for a first time period to drive a first current between the two electrodes;
applying a second voltage to the sample for a second time period to drive a second current between the two electrodes;
calculating an absolute value of the ratio of a value of the first current to a value of the second current as a sample volume index; and
comparing the sample volume index with a predetermined index range to determine if a volume of the sample is insufficient to measure accurately at least one characteristic of the sample;
wherein the first voltage and the second voltage have opposite directions.

2. The method of claim 1, wherein the volume of the sample is determined to be insufficient as the value of the sample volume index is out of the predetermined index range, and wherein the volume of the sample is determined to be sufficient as the value of the sample volume index is within the predetermined index range.

3. The method of claim 1, further comprising:
sending a normality message as the value of the sample volume index is within the predetermined index range; and
sending an error signal as the value of the sample volume index is out of the predetermined index range.

4. The method of claim 1, wherein a positive correlation exists between the predetermined index range and the ratio of a first area to a second area, and a negative correlation exists between the predetermined index range and the ratio of the square root of the first time period to the square root of the second time period, wherein the first area indicates the area of the part of one electrode, and the second area indicates the area of the part of the other electrode.

5. The method of claim 1, wherein the predetermined index range is calculated based on the following equation:
$$\frac{\frac{A 1}{\sqrt{t 1}}}{\frac{A 2}{\sqrt{t 2}}} \times \frac{1}{( 1 + C \% )} ∼ \frac{\frac{A 1}{\sqrt{t 1}}}{\frac{A 2}{\sqrt{t 2}}} \times ( 1 + C \% ) ,$$
wherein a first area A1 indicates the area of the part of one electrode, a second area A2 indicates the area of the part of the other electrode, t1 indicates the first time period, t2 indicates the second time period, and C indicates a tolerance ratio of the electrochemical test strip.

6. The method of claim 1, wherein the first time period and the second time period are between 0.5 seconds and 5 seconds.

7. The method of claim 1, wherein the predetermined index range is between 1.02 and 2.2.

8. The method of claim 1, wherein an absolute value of the first voltage is equal to that of the second voltage and between 0.1 volt and 1 volt.

9. The method of claim 1, further comprising:
interrupting power for a third time period after the step of placing the sample on the reaction portion of the electrochemical test strip.

10. The method of claim 1, wherein the first time period is equal to the second time period.

11. The method of claim 1, wherein the first time period is not equal to the second time period.

12. An electrochemical device for determining sample volume sufficiency of an electrochemical test strip having a reaction portion and two electrodes, wherein parts of the two electrodes are respectively disposed on the reaction portion, the electrochemical device comprising:
a strip accommodating region for accommodating the electrochemical test strip;
a power supply unit for applying a first voltage to a sample for a first time period to drive a first current between the two electrodes, and for applying a second voltage to the sample for a second time period to drive a second current between the two electrodes;
a current sensing unit for obtaining a value of the first current and a value of the second current; and
a processing unit for calculating an absolute value of the ratio of the value of the first current to the value of the second current as a sample volume index, and for comparing the sample volume index with a predetermined index range to determine if a volume of the sample is insufficient to measure accurately at least one characteristic of the sample;
wherein the first voltage and the second voltage have opposite directions.

13. The electrochemical device of claim 12, wherein the volume of the sample is determined to be insufficient as the value of the sample volume index is out of the predetermined index range, and wherein the volume of the sample is determined to be sufficient as the value of the sample volume index is within the predetermined index range.

14. The electrochemical device of claim 12, wherein the processing unit sends a normality message as the value of the sample volume index is within the predetermined index range, and sends an error signal as the value of the sample volume index is out of the predetermined index range.

15. The electrochemical device of claim 12, wherein a positive correlation exists between the predetermined index range and the ratio of a first area to a second area, and a negative correlation exists between the predetermined index range and the ratio of the square root of the first time period to the square root of the second time period, wherein the first area indicates the area of the part of one electrode, and the second area indicates the area of the part of the other electrode.

16. The electrochemical device of claim 12, wherein the predetermined index range is calculated based on the following equation:
$$\frac{\frac{A 1}{\sqrt{t 1}}}{\frac{A 2}{\sqrt{t 2}}} \times \frac{1}{( 1 + C \% )} ∼ \frac{\frac{A 1}{\sqrt{t 1}}}{\frac{A 2}{\sqrt{t 2}}} \times ( 1 + C \% ) ,$$
wherein a first area A1 indicates the area of the part of one electrode, a second area A2 indicates the area of the part of the other electrode, t1 indicates the first time period, t2 indicates the second time period, and C indicates a tolerance ratio of the electrochemical test strip.

17. The electrochemical device of claim 12, wherein the first time period and the second time period are between 0.5 seconds and 5 seconds.

18. The electrochemical device of claim 12, wherein the predetermined index range is between 1.02 and 2.2.

19. The electrochemical device of claim 12, wherein an absolute value of the first voltage is equal to that of the second voltage and between 0.1 volt and 1 volt.

20. The electrochemical device of claim 12, wherein before the power supply unit applies the first voltage, power is interrupted for a third time period.
